(19) United States
(12) Patent Application Publication
(10) Pub. No.: US 2014/0122266 A1
(43) Pub. Date: May 1, 2014

(54) METHOD FOR ACCUMULATING, SPENDING, AND MANAGING ELECTRONIC CENTS

(71) Applicant: William Bishilany, Seven Hills, OH (US)

(72) Inventor: William Bishilany, Seven Hills, OH (US)

(21) Appl. No.: 13/662,448

(22) Filed: Oct. 27, 2012

(51) Int. Cl. G06Q 20/06; G06Q 40/02

(52) U.S. Cl. CPC G06Q 20/0655; G06Q 40/02; H04L 63/10
USPC 705/17; 705/42; 726/4

(57) ABSTRACT

This invention is a software-based solution that allows users to accumulate and spend e-cents in real time during a cash transaction. The invention also allows users to manage their e-cents via smartphone application or web browser interface.

### CROSS-REFERENCE TO RELATED APPLICATIONS

This application claims the benefit of provisional patent application No. 61/554,148, filed on Nov. 1, 2011 by the present inventor.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

1. Field of Invention

The present invention is in the technical field of financial transactions. More particularly, the present invention is in the technical field of accumulating individual user's physical coinage on the “cloud”, and transactions that will be executed using a terminal at a point of sale system.

Total bankruptcy filings in 2009 reached 1.4 million in 2009, up from 1.09 million in 2008. The vast majority were personal bankruptcies—Chapter 7 and Chapter 13. Young Americans now have the second highest rate of bankruptcy, just after those aged 35 to 44. The rate among 25- to 34-year-olds increased between 1991 and 2001, indicating that this generation is more likely to file bankruptcy as young adults than were young boomers at the same age. Undergraduates are carrying record-high credit card balances. The average (mean) balance grew to $3,173, the highest in the years the study has been conducted. Median debt grew from 2004's $946 to $1,645. Twenty-one percent of undergraduates had balances of between 3,000 and $7,000, also up from the last study. Credit card usage fell dramatically from 2007 to 2008, with only 64 percent of consumers indicating they used a credit card in the month preceding the September 2008 survey, compared to 87 percent of users in 2007—a 23 percentage point decline. Consumers are aware that careless credit card spending has played a part in getting us to where we are today.

The present invention offers users an additional and more importantly, a unique cash management solution that will make spending cash easier and more convenient. The cost of manufacturing money has increased to unsustainable levels. The cost for the United States Mint to produce and distribute the cent and nickel rose to their highest levels, and are now more than double the respective face values. For the fiscal year ending Sep. 30, 2011, the unit cost for the cent was 2.41 cents, and the cost for the nickel was 11.18 cents. A number of companies offer solutions that will sort, count, and exchange physical coinage for paper money, while charging the user a nominal fee. These companies currently have coin-counting kiosks in high traffic retail locations. Users can accumulate their physical coinage however they wish and later carry it to a coin-exchanging kiosk. The charge for using a service like this is a flat percentage based fee based on the amount of physical coinage put in the machine. Alternatively, users can accumulate and carry their physical coinage to certain financial institutions that will also exchange physical coinage for paper money; the only stipulation being that the user must be a member of that specific institution.

2. Prior Art

U.S. Pat. No. 5,832,089 by Kravitz, Gemmell, and Brickell, “Off-line compatible electronic cash method and system”, issued Nov. 3, 1998. This patent describes an off-line electronic cash system having an electronic coin, a bank, a payee, and a user with an account at the bank as well as a user password, and a method for performing an electronic cash transfer. An electronic coin is withdrawn from the bank by the user and an electronic record of the electronic coin is stored by the bank. To perform these operations a key pair is generated by the user, including public and secret signature keys. The invention is distinguishable from U.S. Pat. No. 5,832,089. The invention improves upon the patent in providing a method for an on-line electronic cash system, which performs operations without generating a key pair but rather by a link to an encrypted file on a third party web services storage interface.

U.S. application Ser. No. 11/325,910, Publication # US 2007/0080213 A1—“Aggregate electronic change saving method”. This application describes a method for automatic electronic saving of change over the whole dollar amount of purchases using cash, debit cards, credit cards, or any combination of cash, debit cards, and credit cards. For cash purchases, change from the purchase is transferred into the user's designated account by transferring the change from the purchase into the user's account through a point of sale machine.

### BRIEF SUMMARY OF THE INVENTION

The present invention is a method for accumulating, spending, and managing electronic cents. The present invention offers users a simple, convenient, and seamless method of accumulating and spending electronic cents. Through this software-based solution, users are able to accumulate physical coinage in real time rather than walk away with loose change.

### BRIEF DESCRIPTION OF THE SEVERAL VIEWS OF THE DRAWING

FIG. 1 is a summary flow of the present invention;

FIG. 2 is a consumer to merchant (vendor) summary flow of the present invention;

FIG. 3 is a consumer post-purchase flow of the present invention; and

FIG. 4 is a merchant (vendor) post-purchase flow of the present invention.

FIG. 5 is a purchase flow of the present invention.

FIG. 6 is a server flow and user authentication and registration flow of the present invention.

FIG. 7 is an electronic cents to bank transfer flow of the present invention.

### DETAILED DESCRIPTION OF THE INVENTION

This invention is illustrated by the following examples that are merely for the purpose of illustration and are not to be regarded as limiting the scope of the invention or the manner in which it can be practiced.

This invention is a software-based solution that allows users to accumulate and spend e-cents in real time during a cash transaction. The invention also allows users to manage their e-cents via smartphone application or web browser interface. More specifically, the transaction will be completed by custom agent software located within a point of sale (“POS”) terminal.

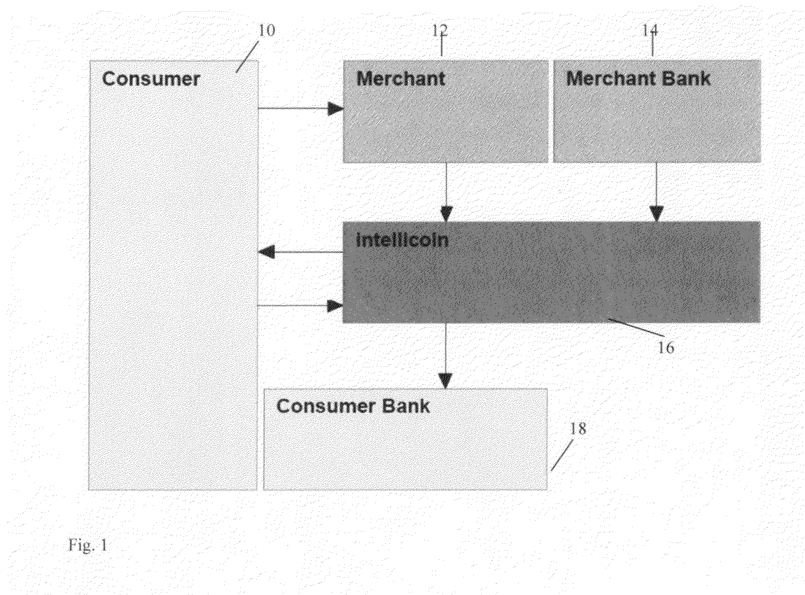

Referring now to the invention in more detail, in FIG. 1 there is shown a consumer 10, a merchant (vendor) 12, a merchant (vendor) bank 14, an intellicoin service 16, and a consumer bank 18. The consumer 10 makes a purchase at a merchant 12 using their intellicoin card. The purchase total is rounded up to the next whole dollar and the consumer 10 pays that rounded amount to the merchant 12. The merchant's point-of-sale system (POS) sends the details of the purchase to the intellicoin service 16 via hypertext transfer protocol secure (HTTPS). The data sent by the merchant 12 POS includes purchase time, purchase total, amount tendered, quantity of intellicoins (electronic cents, or “e-cents”), and, optionally, items purchased. The intellicoin service 16 sends an email and/or short message service (“SMS”) text message to the consumer 10 notifying the consumer 10 that an intellicoin transaction has taken place and informing the consumer 10 of their current intellicoin balance. The consumer 10 may access their intellicoin account via the www.intellicoin.com web site or the intellicoin smartphone application. From this site, the consumer 10 can view their current intellicoin balance, view a history of their intellicoin transactions, and request a transfer of their intellicoin balance to their linked consumer bank 18 account. The intellicoin service 16 processes all consumer 10 requests to transfer intellicoin balances to the consumer bank 18 accounts. The intellicoin service 16 then initiates an automated clearing house (“ACH”) transaction to the consumer bank 18 and transfers the specified amount to the consumer's 10 account held at consumer bank 18. On an agreed upon schedule, the intellicoin service 16 initiates an ACH transaction from the merchant bank 14 to recover the balance of intellicoins from purchases.

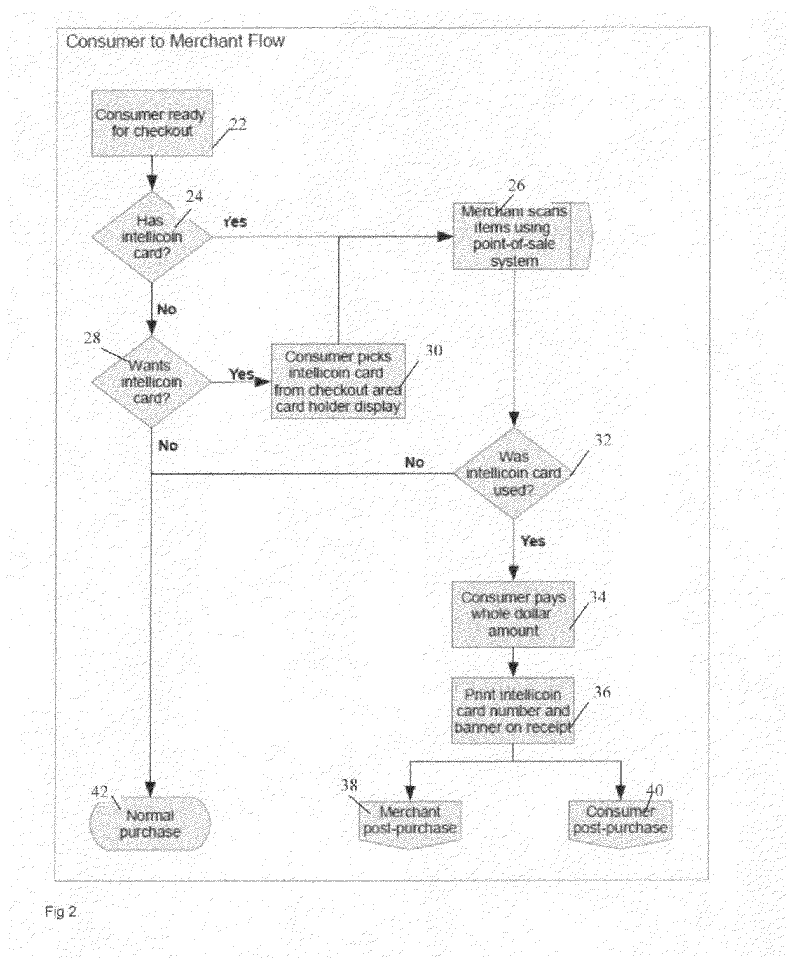

Referring now to the invention shown in FIG. 2 there is shown a consumer 22, an intellicoin card 24, a merchant 26, a consumer desiring an intellicoin card 28, a consumer selecting an intellicoin card 24 from the checkout area card holder display 30, use of an intellicoin card 32, a consumer 22 paying a whole dollar amount 34, a normal purchase with physical change 42, a merchant 26 printing the intellicoin card number and banner on receipt 36, a merchant 26 post-purchase sequence 38, and a consumer 22 post-purchase sequence 40.

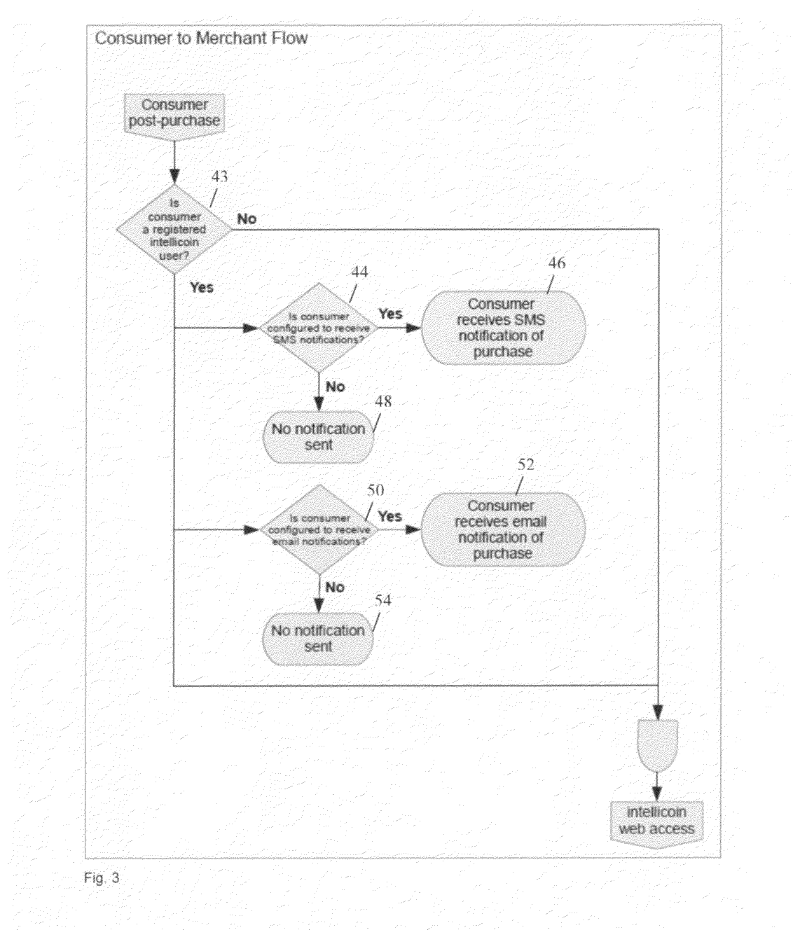

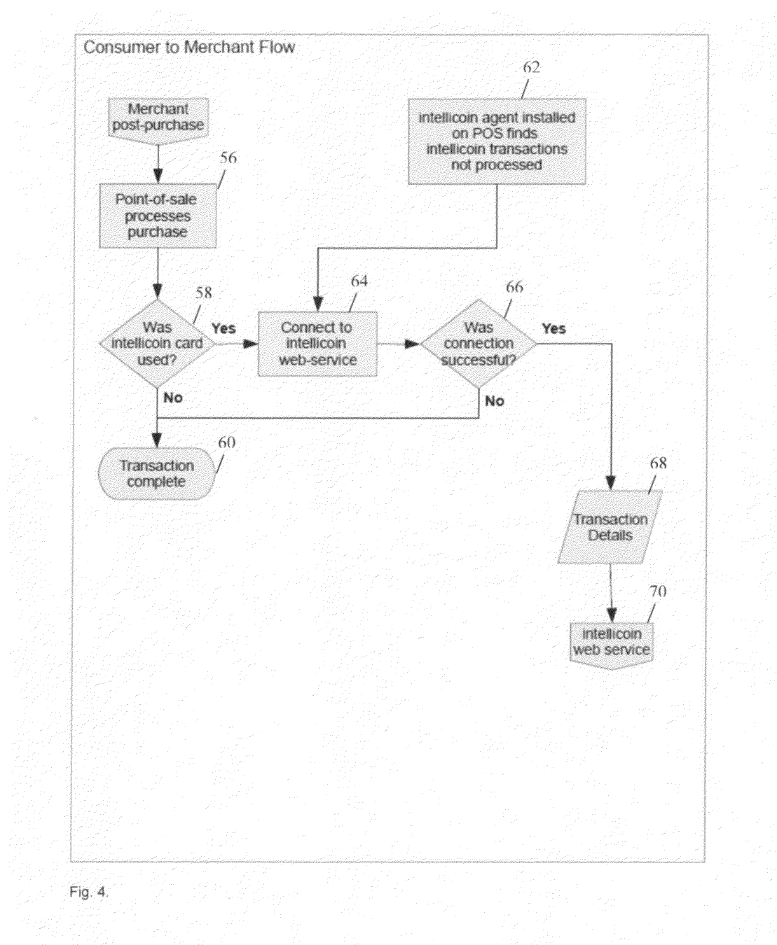

In one instance, the consumer 22 is ready for checkout and has an intellicoin card 24. The merchant 26 scans the items using the merchant's point-of-sale (“POS”) system. The intellicoin card 24 of the consumer 22 was used. Then, the consumer 22 pays a whole dollar amount 34, and the merchant 26 prints the intellicoin card number and banner on receipt 36. The next steps are then a merchant 26 post-purchase sequence 38, and a consumer 22 post-purchase sequence 40, as described herein in FIG. 3 and FIG. 4, respectively.

In another instance, the consumer 22 is ready for checkout and has an intellicoin card 24. The merchant 26 scans the items using the merchant's point-of-sale (“POS”) system. However, the intellicoin card 24 of the consumer 22 was not used. The consumer 22 then proceeds to make a normal purchase with physical change 42.

In another instance, the consumer 22 is ready for checkout without an intellicoin card 24. The consumer 22 desires an intellicoin card 28 and selects an intellicoin card 24 from the checkout area card holder display 30. The merchant 26 scans the items using the merchant's point-of-sale (“POS”) system. The intellicoin card 24 of the consumer 22 was used. Then, the consumer 22 pays a whole dollar amount 34, and the merchant 26 prints the intellicoin card number and banner on receipt 36. The next steps are then a merchant 26 post-purchase sequence 38, and a consumer 22 post-purchase sequence 40, as described herein in subsequent drawings.

In another instance, the consumer 22 is ready for checkout without an intellicoin card 24. The consumer 22 does not desire an intellicoin card 28 and proceeds to make a normal purchase with physical change 42.

Referring now to the consumer post-purchase sequence invention shown in FIG. 3, there is a consumer registered as an intellicoin user 43, a consumer configured to receive SMS notifications 44, a consumer receiving SMS notification of purchase 46, no SMS notification sent 48, a consumer configured to receive email notifications 50, a consumer receiving email notification of purchase 52, and no email notification sent 54.

In one instance, there is a consumer registered as an intellicoin user 43, and the consumer is configured to receive SMS notifications 44. The consumer then receives SMS notification of purchase 46. In another instance, the consumer is not configured to receive SMS notifications 44, where no SMS notification is sent 48.

In another instance, there is a consumer registered as an intellicoin user 43, and the consumer is configured to receive email notifications 50. The consumer then receives email notification of purchase 52. In another instance, the consumer is not configured to receive email notifications 50, and therefore no email notification is sent 54.

In another instance, there is not a consumer registered as an intellicoin user 43, in which this flow ends.

Referring now to the merchant post-purchase invention in FIG. 4 there is shown a point-of-sale processing purchase 56, use of an intellicoin card 58, a transaction complete 60, an intellicoin agent installed on POS that finds intellicoin transactions not processed 62, an attempted connection to the intellicoin web service 64, a decision on connection to the intellicoin web service 66, transaction details 68, and intellicoin web service 70.

In one instance, the point-of-sale processing purchase 56 recognizes use of an intellicoin card 58. There is then an attempted connection to the intellicoin web service 64. The decision on connection to the intellicoin web service 66 is that the connection was successful, and the transaction details 68 are then pushed to the intellicoin web service 70.

In another instance, the point-of-sale processing purchase 56 recognizes use of an intellicoin card 58. There is then an attempted connection to the intellicoin web service 64. The decision on connection to the intellicoin web service 66 is that the connection was not successful, which marks the transaction complete 60.

In another instance, the intellicoin agent installed on POS finds intellicoin transactions not processed 62, and proceeds to an attempted connection to the intellicoin web service 64. The decision on connection to the intellicoin web service 66 is that the connection was successful, and the transaction details 68 are then pushed to the intellicoin web service 70.

In another instance, the intellicoin agent installed on POS finds intellicoin transactions not processed 62, and proceeds to an attempted connection to the intellicoin web service 64. The decision on connection to the intellicoin web service 66 is that the connection was not successful, which marks the transaction complete 60.

In another instance, the point-of-sale processing purchase 56 does not recognize use of an intellicoin card 58, which then marks the transaction complete 60.

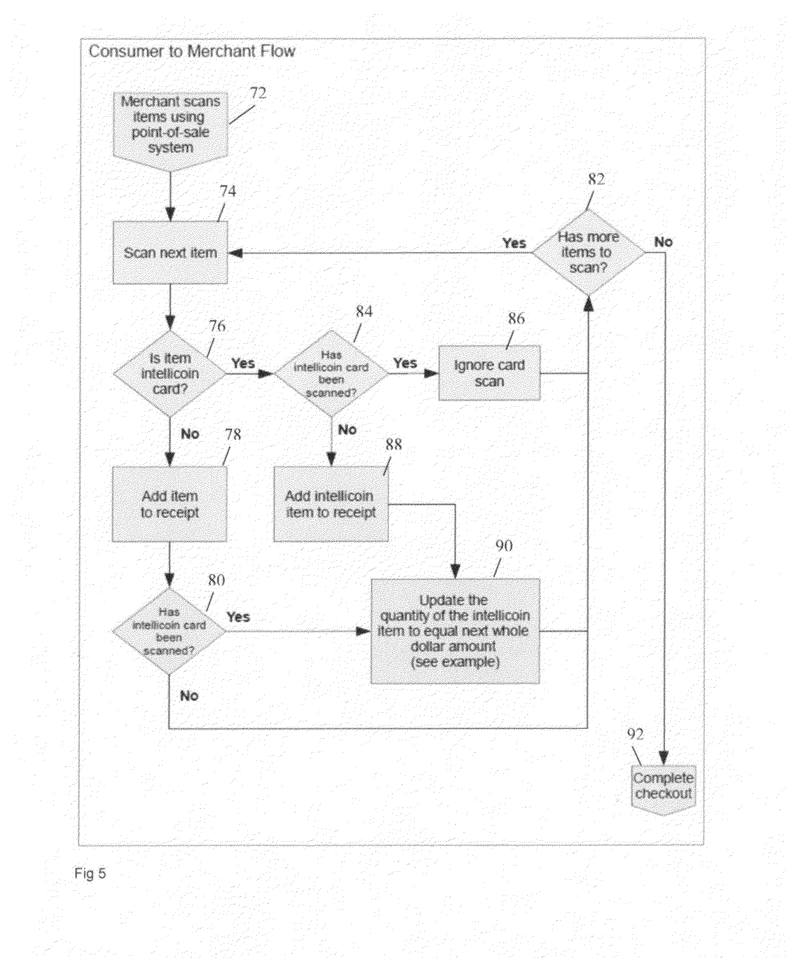

Referring now to the invention in FIG. 5, there is shown a merchant scans items using a point-of-sale system 72, scans the next item 74, intellicoin card scanned 76, adding item to receipt 78, intellicoin card scanned 80, more items to scan 82, intellicoin card scanned 84, ignore card scan 86, add intellicoin item to receipt 88, update quantity of the intellicoin item to equal next whole dollar amount 90, and complete checkout 92.

In one instance, merchant scans items using a point-of-sale system 72, scans the next item 74, which is not an intellicoin card, and that item is added to receipt 78. The intellicoin card has not been scanned 80, yet there are more items to scan 82. This brings the merchant to scan the next item 74.

In another instance, merchant scans items using a point-of-sale system 72, scans the next item 74, which is not an intellicoin card, and that item is added to receipt 78. The intellicoin card has not been scanned 80, and there are no more items to scan 82. This completes checkout 92.

In another instance, merchant scans items using a point-of-sale system 72, scans the next item 74, which is not an intellicoin card, and that item is added to receipt 78. The intellicoin card has been scanned 80, which updates the quantity of the intellicoin item to equal the next whole dollar amount 90. If there are more items to scan 82, then the merchant scans the next item 74. If there are no more items to scan 82, then checkout is complete 92.

In another instance, merchant scans items using a point-of-sale system 72, scans the next item 74, which is an intellicoin card. If the intellicoin card has not been scanned 84, then the intellicoin item is added to receipt 88, which updates the quantity of the intellicoin item to equal the next whole dollar amount 90; and, furthermore, if there are more items to scan 82, then the merchant scans the next item 74; however, if there are no more items to scan 82, then checkout is complete 92. If the intellicoin card has been scanned 84, then the card scan is ignored 86; and, furthermore if there are more items to scan 82, then the merchant scans the next item 74; however, if there are no more items to scan 82, then checkout is complete 92.

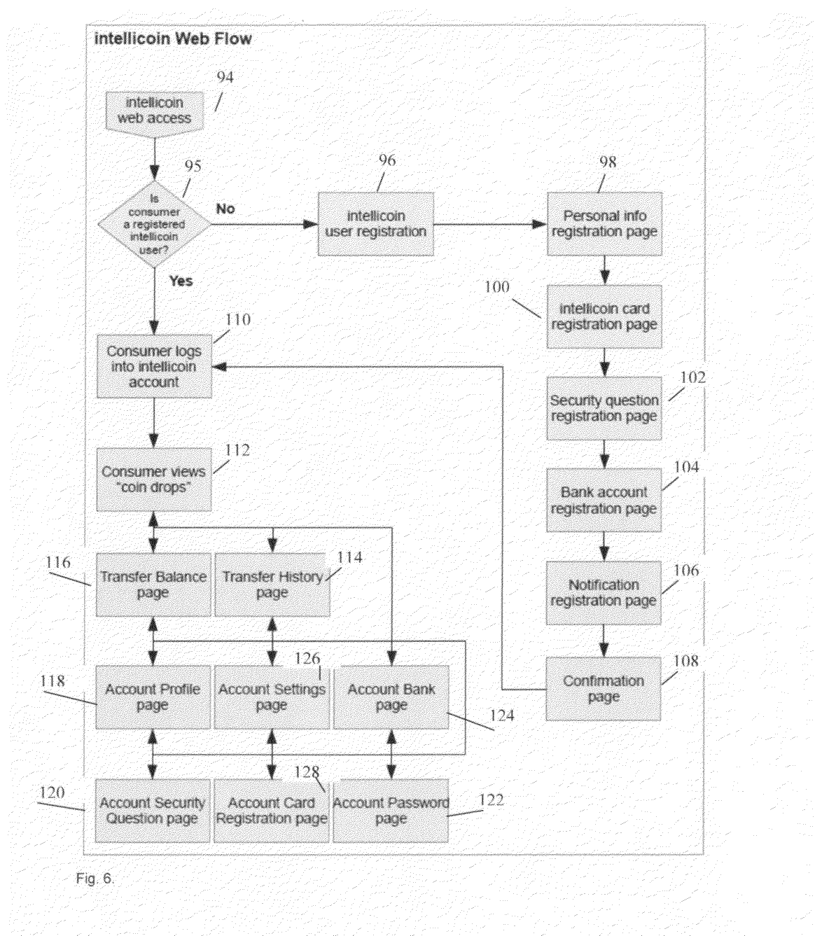

Referring now to the invention in FIG. 6, there is shown an intellicoin web access 94, a consumer registered as an intellicoin user 95, an intellicoin user registration function 96, a personal information registration page 98, an intellicoin card registration page 100, a security question registration page 102, a bank account registration page 104, a notification registration page 106, a confirmation page 108, a consumer logs into intellicoin account 110, a consumer views coin drops (balance) 112, a transfer balance page 116, an account profile page 118, an account security question page 120, an account password page 122, an account bank page 124, an account settings page 126, and an account card registration page 128.

In one embodiment, the information in the personal information registration page 98, intellicoin card registration page 100, security question registration page 102, and bank account registration page 104 leverage long-term storage and links to an encrypted file on a third party web services storage interface to store this client and system data, including client encrypted data with storage of protected client information in Advanced Encryption System 256 bit encrypted files.

In one instance, intellicoin web access 94 is achieved. The consumer is not registered as an intellicoin user 95, and then proceeds to intellicoin user registration 96. After the user completes intellicoin user registration 96, the user then proceeds to the personal information registration page 98. After the user completes their personal information registration page 98, the user then proceeds to an intellicoin card registration page 100. After the user completes the intellicoin card registration page 100 and registers their intellicoin card, then user then proceeds to the security question registration page 102 to complete a series of security questions for password recovery and for additional authentication. After the user completes the security registration page 102, the user then proceeds to the bank account registration page 104. After the user registers his bank account with intellicoin on the bank account registration page 104, the user then sees a notification registration page 106 and then a registration confirmation page 108, which confirms their registration with intellicoin.

In another instance, intellicoin web access 94 is achieved. The consumer is registered as an intellicoin user 95, and the user logs into their intellicoin account 110. The consumer views their coin drops 110 (balance). The consumer can then view their transfer balance page 116, transfer history page 114, account profile page 118, account settings page 126, account security question page 120, account card registration page 128, or their account password page 122.

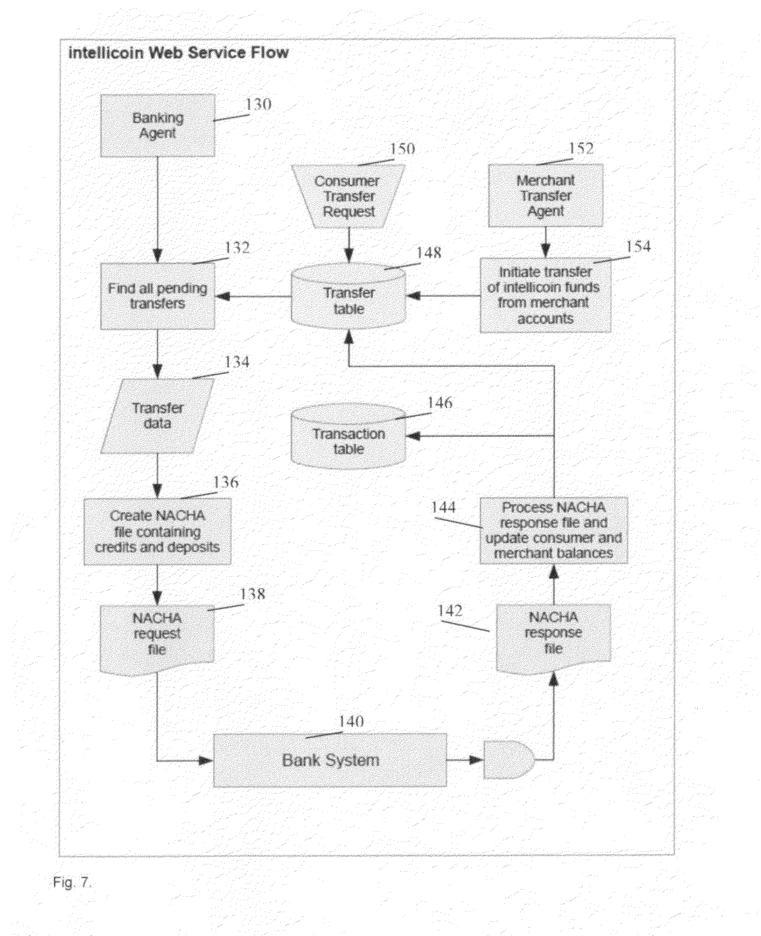

Referring now to the invention in FIG. 7, there is shown a banking agent 130, find all pending transfers 132, transfer data 134, create National Automated Clearing House Association (“NACHA”) file containing credits and deposits 136, NACHA request file 138, Bank System 140, NACHA response file 142, process NACHA response file and update consumer and merchant balances 144, transaction table 146, transfer table 148, consumer transfer request 150, merchant transfer agent 152, and initiate transfer of intellicoin funds from merchant accounts 154.

Further referring to the invention in FIG. 7, where the consumer transfers their intellicoin balance to a bank, the consumer chooses to sweep their intellicoin balance to their registered bank account. The consumer submits a sweep request via browser or smartphone application. The intellicoin banking agent 130 batches the request, waiting for an ACH window. At a later time, the banking agent 130 finds all pending transfers 132 and the banking agent 130 builds an ACH submission file for all of the pending ACH transactions. Then, intellicoin submits the ACH submission file and transfers the data 134, creating a NACHA file containing credits and deposits 136 and a NACHA request file 138. The Bank System 140 then processes the NACHA request file 138 and prepares the NACHA response file 142. The Bank System 140 processes the NACHA response file and updates the consumer and merchant balances 144. The NACHA response file and updated consumer and merchant balances 144 are simultaneously sent to the transaction table 146 and to the transfer table 148. The transfer table consists of the processes the NACHA response file and updates the consumer and merchant balances 144, consumer transfer requests 150, initiated transfers of intellicoin funds from merchant accounts 154 by merchant transfer agent 152. The transfer table 148 sends statuses when transfers are complete (1-3 days). The Consumer views their intellicoin balance and, if ACH was successful, sees that the funds were transferred. The Consumer views their intellicoin balance and, if ACH failed, sees an error message detailing the reason the transaction failed.

Therefore, disclosed herein is:

1. A method for electronically accumulating a change in electronic cents (“e-cents”), comprising:
a. at a consumer or a vendor, a purchasing of items at a purchase total
b. at an account designated by a consumer and a card linked to the account, the consumer or the vendor scanning or swiping the card at a vendor's point-of-sale system (“POS”)
c. at the consumer, tendering cash to the vendor at a tendered amount that equals the purchase total rounded up to the next whole dollar
d. at an agent installed at the POS, determining purchase information, including the purchase total, and computing a change amount that equals the e-cents amount in the purchase total
e. at the POS, collecting the purchase information and transmitting the purchase information to a service
f. at the service, receiving the purchase information and verifying the account
g. at the service, using the purchase information to add a change to the account that equals the difference between the tendered amount and the purchase total
h. at the service, reconciling the account balance
i. at the service, signaling the agent on intellicoin transaction information
j. at the agent, signaling the intellicoin transaction information to the POS
k. at the POS, printing a POS transaction information and the intellicoin transaction information on a receipt
l. at the vendor, completing the purchasing
m. at the service, initiating an automated clearing house (“ACH”) pull transaction from the vendor's bank to recover the change amount from the purchase and crediting the account at the change amount.

Purchase information includes purchase time, purchase total, amount tendered, quantity of intellicoins, and, optionally, items purchased. One embodiment of the purchase information is in a data structure with the following members: intellicoin identification (“ID”) (from card), vendor ID, POS ID (if available), event ID (credit to intellicoin or debit from intellicoin), purchase total (example: $4.78), tendered amount (example: $5), quantity of e-cents (“intellicoins”) (example: 22), and, optionally, a list of Universal Products Codes from purchased items.

In a similar embodiment, intellicoin transaction information includes transaction ID, intellicoin amount (example: $0.22), cash due to consumer (example: $0), and current balance of consumer account.

In an embodiment of the consumer using intellicoin at a Vendor, the consumer purchases items totally, for example, $4.78 at an intellicoin Vendor. The consumer chooses to use cash for the transaction, and gives Vendor a $5 bill and the consumer's intellicoin card. The vendor selects Cash w/intellicoin option on their POS and scans or swipes the consumer's intellicoin card. The POS sends the following information to intellicoin servers: intellicoin ID (from card), Vendor ID, POS ID (if available), Event ID (credit to intellicoin), Purchase total ($4.78), Tendered amount ($5), and list of UPCs from purchased items (optionally). Then, intellicoin verifies the intellicoin ID and accepts the transaction, calculates the change, and adds the change amount to the Consumer's intellicoin account ($0.22). Then, intellicoin sends a response to the vendor's POS containing the following information: Transaction ID, intellicoin amount ($0.22), Cash due Consumer ($0), and Current balance of Consumer account. The vendor's POS records the intellicoin amount and displays cash due Consumer to Vendor. Finally, the vendor closes the sale and the vendor's POS prints the intellicoin transaction and current Consumer balance on the receipt. Post-transaction, the consumer can view their transaction information and current balance on the receipt, via smartphone application, or via web browser.

In another embodiment of the consumer using intellicoin at the vendor with cash back, the consumer purchases items totaling, for example, $6.80 at an intellicoin Vendor. The consumer chooses to use cash for transaction. The consumer gives vendor a $10 bill and their intellicoin card. The vendor selects Cash w/intellicoin option on their POS and scans or swipes the intellicoin card. The POS sends the following information to intellicoin servers: intellicoin ID (from card), Vendor ID, POS ID (if available), Event ID (credit to intellicoin), Purchase total ($6.80), Tendered amount ($10), List of UPCs from purchased items (optionally). Intellicoin then verifies the intellicoin ID and accepts the transaction, calculates the change; and adds the change amount to the consumer's account ($0.20). Then, intellicoin sends a response to the POS containing the following information: Transaction ID, intellicoin amount ($0.20), Cash due Consumer ($3.00), and Current balance of Consumer account. The POS records the intellicoin amount and displays to the Vendor the cash due to Consumer. The Vendor gives the Consumer $3 and closes the sale. The POS prints the intellicoin transaction and current Consumer balance on a receipt. The Consumer can then view their transaction information and current balance on the receipt, via smartphone application, or via the web.

In another embodiment of the consumer attempting to use an invalid intellicoin account, the consumer purchases items totaling, for example, $14.43 at an intellicoin Vendor, and chooses to use cash for the transaction. The Consumer gives Vendor $15 and an intellicoin card. The Vendor selects Cash w/intellicoin option on their POS and scans or swipes the consumer's intellicoin card. The POS sends the following information to intellicoin servers: intellicoin ID (from card), Vendor ID, POS ID (if available), Event ID (credit to intellicoin), Purchase total ($14.43), Tendered amount ($15), and list of UPCs from purchased items (optionally). Then, intellicoin identifies the intellicoin ID as either an invalid number or a closed account, to which intellicoin rejects the transaction and sends a response to POS containing the following information: Transaction ID, and Failure code (Invalid Account). The intellicoin agent installed on the vendor's POS recognizes the failure code and defaults to Cash tender, where the Vendor gives the Consumer $0.57 and closes the sale. The POS does not print any intellicoin information on the receipt.

In one embodiment of intellicoin initiating an automated clearing house (“ACH”) pull transaction from the vendor's bank to recover the change amount from the purchase, intellicoin builds an ACH submission file for all of the Vendor accounts in which payment is due. Then, intellicoin submits the ACH submission file to the vendor's bank during an approved window. The vendor's bank processes the ACH transactions and sends statuses when transfers are complete (1-3 days). Then, intellicoin receives statuses, identifies any errors, and resubmits errored transactions (when applicable).

Also disclosed herein is a method for electronically spending a change in electronic cents (“e-cents”), comprising:

a. at a consumer or a vendor, a purchasing of items at a purchase total
b. at an account designated by a consumer and a card linked to the account, the consumer or the vendor scanning or swiping the card at a vendor's point-of-sale system (“POS”)
c. at the consumer, tendering cash to the vendor at a tendered amount that equals the purchase total rounded down to the whole dollar, and tenders a purchase change in e-cents at that equals the difference between the purchase total and the tendered amount
d. at an agent installed at the POS, determining purchase information, including the purchase total, and computing a change amount that equals the e-cents amount in the purchase total
e. at the POS, collecting the purchase information and transmitting the purchase information to a service
f. at the service, receiving the purchase information and verifying the account
g. at the service, using the purchase information to subtract a change from the account at the purchase change amount
h. at the service, reconciling the account balance
i. at the service, signaling the agent on intellicoin transaction information
j. at the agent, signaling the intellicoin transaction information to the POS
k. at the POS, printing a POS transaction information and the intellicoin transaction information on a receipt
l. at the vendor, completing the purchasing

In one embodiment of the consumer paying for a purchase using intellicoin, the Consumer purchases items totaling, for example, $7.72 at an intellicoin Vendor. The Consumer chooses to use cash for the transaction and their intellicoin card for the change portion. The Consumer gives Vendor a $10 bill and their intellicoin card. The Vendor selects Cash w/intellicoin option on their POS and scans or swipes the consumer's intellicoin card. The POS sends the following information to intellicoin servers: intellicoin ID (from card), Vendor ID, POS ID (if available), Event ID (debit from intellicoin), Purchase total ($7.72), Tendered amount ($10), and list of UPCs from purchased items (optionally). Then, intellicoin verifies the intellicoin ID and accepts the transaction, calculates the change, and subtracts the change amount from Consumer account ($0.72). Then, intellicoin sends response to the vendor's POS containing the following information: Transaction ID, intellicoin amount (−$0.72), Cash due Consumer ($3.00), and Current balance of Consumer account. The vendor's POS records the intellicoin amount and displays cash due Consumer to Vendor. The Vendor gives the Consumer $3 and closes sale, and the POS prints intellicoin transaction and current Consumer balance on the receipt. Post-transaction, the Consumer can view their transaction information and current balance on the receipt, via smartphone application, or via web browser.

In another embodiment of the consumer paying for a purchase using intellicoin with insufficient funds, the Consumer purchases items totaling, for example, $8.18 at an intellicoin Vendor. The Consumer chooses to use cash for transaction and their intellicoin card for the change portion. The Consumer gives the Vendor a $10 bill and their intellicoin card. The Vendor selects Cash w/intellicoin option on POS and scans or swipes intellicoin card. The POS sends the following information to intellicoin servers: intellicoin ID (from card), Vendor ID, POS ID (if available), Event ID (debit from intellicoin), Purchase total ($8.18), Tendered amount ($10), and list of UPCs from purchased items (optionally). Then, intellicoin verifies the intellicoin ID and accepts the transaction, calculates the change, and attempts to subtract the change amount from the consumer account ($0.82). Then, intellicoin identifies that the Consumer does not have enough money in their account and sends a response to POS containing the following information: Transaction ID, and Failure code (Insufficient Funds). The POS recognizes the failure code and displays a message to Vendor asking if the Consumer would like to add the funds to their intellicoin account instead. If the Consumer chooses to add the funds, the POS restarts the transaction with a credit event ID. If the Consumer chooses not to add the funds, the POS reverts to a Cash tender and physical change is given.

Also disclosed herein is a method for managing a change between a server and a consumer using a network, comprising:

a. At an application, accessing a home page of the server through the network
In one embodiment, the application is an intellicoin-developed smartphone application with interfaces to the intellicoin web service. In another embodiment, the application is a web browser with interfaces to the intellicoin web service.
b. at the home page, inputting by the consumer a consumer identity and a password into the home page, and the application sending an authentication to the server through the network
c. at the server, returning an authentication token to the application through the network
d. at the application, sending the authentication token through the network and to the server along with request for access.
e. at the server, accepting the authentication token. In one embodiment, the authentication token expires after five minutes of consumer inactivity and the server rejects the authentication token.

The server sends a message to the consumer notifying the consumer that a transaction has taken place, and informing the consumer of their current account balance. In one embodiment, the intellicoin service sends an SMS message to the consumer's phone. In another embodiment, the intellicoin service sends an email message to the consumer's registered email address.

In one embodiment where the consumer views their balance via phone, the consumer wishes to view their intellicoin account balance via the intellicoin smartphone application. The consumer opens their intellicoin smartphone application and logs in. The intellicoin smartphone application sends an authentication to intellicoin servers and the intellicoin server returns an authentication token. The consumer navigates to the Account Balance page. Then, the intellicoin smartphone application sends an authentication token to intellicoin servers along with request for the Account Balance. The intellicoin server accepts the authentication token and sends the account balance information to the smartphone application. When the Consumer waits more than 5 minutes and attempts to navigate to another page, the intellicoin smartphone application sends an authentication token to intellicoin servers along with the page request, and the intellicoin server rejects the expired authentication token and forces the Consumer to relogin.

In another embodiment where the consumer views their balance via a web browser, the Consumer wishes to view their intellicoin account balance via www.intellicoin.com. The consumer then navigates to www.intellicoin.com using their web browser and logs into their account. The browser sends the authentication information to intellicoin servers and the intellicoin server returns an authentication token. The consumer navigates to the Account Balance page, and the browser sends authentication token to intellicoin servers along with the Account Balance request. The intellicoin server accepts the authentication token and sends the account balance information to the browser. When the consumer waits more than 5 minutes and attempts to navigate to another page, the browser sends the authentication token to intellicoin servers along with the consumer's request, and the intellicoin server rejects the expired authentication token and forces the Consumer to relogin.

In another embodiment where the consumer modifies their personal information, independent of whether the consumer interacts with intellicoin via smartphone application or the web browser, the consumer navigates to intellicoin and logs into their account. The smartphone application or browser sends an authentication to intellicoin servers and the intellicoin server returns an authentication token. The consumer navigates to the Account page and updates their address. The smartphone application or browser sends an authentication token to the intellicoin servers along with the request. The intellicoin server accepts the authentication token and sends an address update request to the intellicoin encryption server. The encryption server encrypts the address information and stores the information in a new version of the Consumer's personal file. The intellicoin server returns successful update response to the smartphone application or browser.

In another embodiment where the consumer transfers their intellicoin balance to a bank, the consumer chooses to sweep their intellicoin balance to their registered bank account. The consumer submits a sweep request via browser or smartphone application. The intellicoin server batches the request, waiting for an ACH window. At a later time, intellicoin builds an ACH submission file for all of the pending ACH transactions. Then, intellicoin submits the ACH submission file to the bank. The Bank processes the ACH transactions and sends statuses when transfers are complete (1-3 days). The Consumer views their intellicoin balance and, if ACH was successful, sees that the funds were transferred. The Consumer views their intellicoin balance and, if ACH failed, sees an error message detailing the reason the transaction failed. In another embodiment where the consumer uses their balance to purchase a gift card, the Consumer chooses to use some of their intellicoin balance to purchase gift cards. The Consumer submits the request via browser or smartphone application. Then, intellicoin uses the gift card vendor's application programming interface (“API”) to show available gift cards. The Consumer chooses a gift card and amount, and registers with the gift card vendor and provides email address and/or home address. Then, intellicoin pays for the gift card using Consumer funds. Finally, the Gift card vendor sends the gift card to Consumer via email or physical mail.

In another embodiment where the consumer uses their balance to donate to charity, the Consumer chooses to use some of their intellicoin balance to donate to charity. The Consumer submits the request via browser or smartphone application. Then, intellicoin provides a list of charities to Consumer, where Consumer chooses a donation and amount. Then, intellicoin submits the donation to Charity using Consumer funds. Finally, the Charity sends an acknowledgment to Consumer via email or physical mail.

The advantages of the present invention over the prior art include an improvement upon U.S. Pat. No. 5,832,089 by providing a method for an on-line electronic cash system, which performs operations without generating a key pair but rather by a more efficient (e.g. less handshakes and transactions) method of linking an encrypted file on a third party web services storage interface. The advantages of the present invention over U.S. application Ser. No. 11/325,910 are that this invention also contemplates spending electronic cents through a POS machine, and accumulating and spending electronic cents through a kiosk. Also, this invention can accumulate both electronic cents and vendor loyalty cards through a POS machine.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A method for electronically accumulating a change in electronic cents (“e-cents”), comprising:
a. at a consumer or a vendor, a purchasing of items at a purchase total
b. at an account designated by a consumer and a card linked to the account, the consumer or the vendor scanning or swiping the card at a vendor's point-of-sale system (“POS”)
c. at the consumer, tendering cash to the vendor at a tendered amount that equals the purchase total rounded up to the next whole dollar
d. at an agent installed at the POS, determining purchase information, including the purchase total, and computing a change amount that equals the e-cents amount in the purchase total
e. at the POS, collecting the purchase information and transmitting the purchase information to a service
f. at the service, receiving the purchase information and verifying the account
g. at the service, using the purchase information to add a change to the account that equals the difference between the tendered amount and the purchase total
h. at the service, reconciling the account balance
i. at the service, signaling the agent on intellicoin transaction information
j. at the agent, signaling the intellicoin transaction information to the POS
k. at the POS, printing a POS transaction information and the intellicoin transaction information on a receipt
l. at the vendor, completing the purchasing
m. at the service, initiating an automated clearing house (“ACH”) pull transaction from the vendor's bank to recover the change amount from the purchase and crediting the account at the change amount.

2. The method of claim 1, whereby in additional step (n) the consumer requests a transfer of a specified amount of e-cents from the account to a consumer's linked bank account, and in additional step (o) the service initiates an automated clearing house (“ACH”) transaction to the consumer's bank, and in additional step (p) the service transfers the specified amount of e-cents to the consumer's linked bank account.

3. The method of claim 1, whereby in step (d) the agent rounds the purchase total up to any additional amount of money the consumer wishes to save in addition to the e-cents over the whole dollar amount of the purchase price.

4. The method of claim 1, whereby in step (c) the consumer tenders an amount that equals the sum of the purchase total rounded up to the next whole dollar and an additional whole dollar amount specified by the consumer, and where in step (l) the vendor completes by the purchase by additionally giving the consumer cash in the additional whole dollar amount specified by the consumer.

5. The method of claim 1, whereby the service reconciles a plurality of POS purchases by initiating a plurality of pull transactions from multiple vendor banks to recover a plurality of change from a plurality of consumers' purchases, and whereby the service places the plurality of changes into a plurality of consumers' accounts.

6. The method of claim 1, whereby in step (c) the consumer makes a purchase using debit card.

7. The method of claim 1, whereby in step (c) the consumer makes a purchase using a credit card.

8. The method of claim 1, whereby in step (f) the service identifies the account as either an invalid number or a closed account and rejects the transaction,
and whereby in step (i) the service sends the agent a set of rejected transaction information,
and whereby in step (k) the POS recognizes the failure code and defaults to a cash tender,
and whereby in step (l) the vendor completes the purchase by tendering a physical change to the consumer in the change amount,
and whereby step (m) is omitted.

9. A method for electronically spending a change in electronic cents (“e-cents”), comprising:
a. at a consumer or a vendor, a purchasing of items at a purchase total
b. at an account designated by a consumer and a card linked to the account, the consumer or the vendor scanning or swiping the card at a vendor's point-of-sale system (“POS”)
c. at the consumer, tendering cash to the vendor at a tendered amount that equals the purchase total rounded down to the whole dollar, and tenders a purchase change in e-cents at that equals the difference between the purchase total and the tendered amount
d. at an agent installed at the POS, determining purchase information, including the purchase total, and computing a change amount that equals the e-cents amount in the purchase total
e. at the POS, collecting the purchase information and transmitting the purchase information to a service
f. at the service, receiving the purchase information and verifying the account
g. at the service, using the purchase information to subtract a change from the account at the purchase change amount
h. at the service, reconciling the account balance
i. at the service, signaling the agent on intellicoin transaction information
j. at the agent, signaling the intellicoin transaction information to the POS
k. at the POS, printing a POS transaction information and the intellicoin transaction information on a receipt
l. at the vendor, completing the purchasing

10. The method of claim 8, whereby in step (c) the consumer tenders cash to the vendor at a tendered amount that equals a whole dollar amount greater than the purchase total, and tenders a purchase change in e-cents that equals the difference between the purchase amount and the purchase amount rounded down to the whole dollar.

11. The method of claim 8, whereby in step (g) the service identifies insufficient change in the account,
and whereby in step (i) sends the agent a set of rejected intellicoin transaction information,
and whereby in step (k) the POS recognizes the failure code and displays a message to the vendor asking if the consumer would like to add the change to the consumer's account,
and whereby the consumer chooses to add the funds, and whereby the POS restarts the purchasing.

12. The method of claim 8, whereby in step (g) the service identifies insufficient change in the account,
and whereby in step (i) sends the agent a set of rejected intellicoin transaction information,
and whereby in step (k) the POS recognizes the failure code and displays a message to the vendor asking if the consumer would like to add the funds to the consumer's account,
and whereby the consumer chooses not to add the funds, and whereby the POS reverts to a cash tender and the vendor tenders a physical change to consumer.

13. The method of claim 8, whereby in step (f) the service identifies the account as either an invalid number or a closed account, and rejects the transaction,
and whereby in step (i) sends the intellicoin agent a set of rejected intellicoin transaction information,
and whereby in step (k) the POS recognizes the failure code and defaults to a cash tender,
and whereby in step (l) the vendor completes the purchase by tendering a physical change to the consumer in the change amount

14. A method for managing a change between a server and a consumer using a network, comprising:
a. At an application, accessing a home page of the server through the network
b. at the home page, inputting by the consumer a consumer identity and a password into the home page, and the application sending an authentication to the server through the network
c. at the server, returning an authentication token to the application through the network
d. at the application, sending the authentication token through the network and to the server along with request for access
e. at the server, accepting the authentication token

15. The method of claim 13, whereby the server rejects an expired authentication token and forces the consumer to re-access the home page of the server

16. The method of claim 13, whereby the server sends an account balance information to the application

17. The method of claim 13, whereby the server is configured to process and display the application's request to transfer change balances from the consumer's account to a bank account linked to consumer,
and whereby the server is configured to process the application's request to electronically donate to a charity of the consumer's choice,
and whereby the server is configured to process the application's request to purchase a gift card of the consumer's choice.

18. The method of claim 13, whereby the server is configured to process the application's request to view a history of the consumer's transactions.

19. The method of claim 13, whereby the server sends a message to the consumer notifying the consumer that a transaction has taken place, and informing the consumer of their current account balance.
